(19) United States
(12) Patent Application Publication
(10) Pub. No.: US 2006/0057437 A1
(43) Pub. Date: Mar. 16, 2006

(54) Direct liquid fuel cell and method of peventing fuel decomposition in a direct liquid fuel cell

(75) Inventors: Gennadi Finkelshtain, Shoham (IL); Yuri Katsman, Hadera (IL); IIan Sadon, Kefar Uria (IL); Mark Estrin, Meuhad (IL); Alexander Litvinov, Netanya (IL); Boris Ilyushin, Novosibirsk (RU); Alexander Chinak, Novosibirsk (RU); Alexander Bluvstein, Lod (IL); Michael Lerner, Kiddush Ha-Shem (IL)

Correspondence Address: GREENBLUM & BERNSTEIN, P.L.C., 1950 ROLAND CLARKE PLACE, RESTON, VA, 20191, US

(73) Assignee: More Energy Ltd., Yehud (IL)

(21) Appl. No.: 11/226,222

(22) Filed: Sep. 15, 2005

Related U.S. Application Data
(63) Continuation-in-part of application No. 10/941,020, filed on Sep. 15, 2004.

(51) Int. Cl. H01M 8/00

(52) U.S. Cl. 429/12; 429/13

(57) ABSTRACT

A direct liquid fuel cell includes a cathode, an anode, a fuel chamber, and at least one membrane arranged between the anode and the fuel chamber. The membrane is structured and arranged to allow gas which is formed on or in the vicinity of the surface of the anode which faces the fuel chamber to accumulate adjacent to the anode at least to a point where the accumulated gas substantially prevents a direct contact between the anode and the liquid fuel. A method of preventing or reducing fuel decomposition in the fuel cell is also disclosed. This Abstract is not intended to define the invention disclosed in the specification, nor intended to limit the scope of the invention in any way.

### CROSS-REFERENCE TO RELATED APPLICATIONS

The present application is a continuation-in-part of U.S. application Ser. No. 10/941,020 filed Sep. 15, 2004, the disclosure of which is expressly incorporated by reference herein in its entirety.

### BACKGROUND OF THE INVENTION

1. Field of the Invention

The present invention relates to a Direct Liquid Fuel Cell (DLFC) which uses a hydride fuel and also relates to specifically preventing or at least substantially reducing the generation of hydrogen caused by a decomposition of the hydride fuel at the anode of the fuel cell when the DLFC is under no or only a low load.

A hydride fuel decomposition reaction at the anode of the fuel cell generates hydrogen during the period where the fuel cell is under no or only a low load. The invention thus also provides a method which uses the generated hydrogen to provide a separation layer between the anode and the liquid fuel. In this way, the fuel is substantially prevented from contacting the anode, whereby decomposition of the fuel is prevented to at least a substantial extent.

One way in which this can be accomplished is by arranging a special membrane close to or in contact with that surface of the anode which faces the fuel chamber. The initially generated hydrogen accumulates between the membrane and the anode, and pushes or forces out the liquid fuel from the space between the anode and the membrane. This causes the liquid fuel to separate from the anode.

2. Discussion of Background Information

The most commonly used liquid fuel for a DLFC is methanol. The main disadvantages of such Direct Methanol Fuel Cells (DMFCs) are the toxicity of methanol and the very poor discharge characteristics at room temperature. As a result, DMFCs are not generally used for portable electronics applications and the like.

Fuels based on (metal) hydride and borohydride compounds such as, e.g., sodium borohydride have a very high chemical and electrochemical activity. Consequently, DLFCs which use such fuels have extremely high discharge characteristics (current density, specific energy, etc.) even at room temperature.

For example, the electro-oxidation of borohydride fuels on the anode surface of a fuel cell occurs in accordance with the following equation:
BH₄⁻+8OH⁻=BO₂⁻+6H₂O+8e⁻ (1)

The main problem associated with hydride and borohydride fuels is a spontaneous decomposition of the fuel on the (active layer of the) anode surface which is accompanied by a generation of hydrogen, usually in the form of microbubbles, e.g., bubbles of from about 0.01 to about 2 mm in size. This process is particularly significant in a DLFC open circuit regime and in a stand-by (low current) regime.

The decomposition of a borohydride compound occurs according to the following equation:
BH₄⁻+2H₂O→BO₂⁻+4H₂↑ (2)

Hydride and borohydride decomposition at the anode of a DLFC results in several technical problems, in particular, energy loss, destruction of the anode active layer, and decreasing safety characteristics. As a result, there is a need to develop ways to substantially prevent the fuel from decomposing while the DLFC is under no or no substantial load.

### SUMMARY OF THE INVENTION

The present invention provides a liquid fuel cell for use with a liquid fuel that is prone to undergo decomposition on the surface of the anode and generates gas in the course of this decomposition. The fuel cell comprises a cathode, an anode, an electrolyte chamber which is arranged between the cathode and the anode, a fuel chamber which is arranged on that side of the anode which is opposite to the side which faces the electrolyte chamber, and at least one membrane which is arranged on that side of the anode which faces the fuel chamber. The at least one membrane is structured and arranged to allow gas which is formed, as a result of the fuel decomposition, on or in the vicinity of the surface of the anode that faces the fuel chamber to accumulate adjacent to the anode at least to a point where the gas substantially prevents a direct contact between the anode and the liquid fuel when liquid fuel is present in the fuel chamber.

According to one aspect of the fuel cell of the present invention, the fuel may comprise a metal hydride and/or borohydride compound and/or the gas may comprise hydrogen.

In another aspect, the at least one membrane may comprise a single layer of material and/or the at least one membrane may comprise a hydrophilic material. The hydrophilic material may comprise a metal and/or a metal alloy. By way of non-limiting example, the hydrophilic material may comprise stainless steel.

In another aspect, the at least one membrane may comprise a hydrophobic material, for example, an organic polymer such as, e.g., a polyolefin (for example, homo- and copolymers of ethylene and propylene), a polyamide and polyacrylonitrile.

In another aspect, the at least one membrane may comprise one or more of a non-woven material, a composite material, a laminate material, a composite/laminate material, a foam material, a porous paper material, a cloth material, a carbon material (e.g. graphite), a sintered metal material, a ceramic material, and a polymer material.

In yet another aspect of the fuel cell of the present invention, the at least one membrane may comprise a foam and/or a mesh, for example, a stainless steel micromesh. For example, the micromesh may comprise cells which have a size of up to about 0.5 mm, e.g., of from about 0.06 μm to about 0.05 mm. In a still further aspect, the at least one membrane (mesh) may have a thickness of from about 0.01 mm to about 5 mm, for example, form about 0.03 mm to about 3 mm, or from about 0.05 mm to about 0.3 mm.

In a still further aspect, the at least one membrane may comprise a polymer mesh and/or a porous polymer layer. For example, the polymer mesh or porous polymer layer may have a thickness of from about 0.02 mm to about 2 mm and/or a cell size of from about 0.01 mm to about 0.1 mm or a pore size of from about 0.01 μm to about 0.1 mm.

In another aspect of the fuel cell of the present invention, the at least one membrane may be in contact with the surface of the anode which faces the fuel chamber. For example, the at least one membrane may be attached and/or bonded to the surface of the anode (e.g., rolled onto the anode).

In another aspect, the fuel cell may further comprise a free space and/or a spacer structure that is arranged between the at least one membrane and the anode. By way of non-limiting example, the spacer structure may comprise a spacer material having free space therein.

In one aspect, the spacer structure may comprise a layer of spacer material having a thickness of up to about 3 mm and/or at least about 0.1 mm. For example, the layer of spacer material may have a thickness of from about 0.5 mm to about 1.5 mm.

In another aspect, the spacer material may comprise a hydrophobic material (e.g., in combination with a membrane that comprises a hydrophilic material) such as, e.g., a polymeric material. By way of non-limiting example, the hydrophobic material may comprise one or more of an olefin homopolymer (e.g., polyethylene, polypropylene, polytetrafluoroethylene), an olefin copolymer, ABS, polymethyl methacrylate, polyvinyl chloride, and a polysulfone.

In yet another aspect, the spacer structure may comprise a net such as, e.g., a wattled net. The net may, for example, comprise openings of from about 1 mm to about 50 mm.

In a still further aspect, the spacer structure may comprise, instead of or in addition to the spacer material that has free space therein, a frame seal which is arranged on the surface of the anode which faces the fuel chamber. The frame seal may comprise a hydrophobic material, for example, a polymer such as, e.g., a fluorinated polymer (e.g., polytetrafluoroethylene). Further, the frame seal preferably has a thickness of up to about 0.1 mm, e.g., a thickness of from about 0.02 mm to about 0.05 mm.

Especially in cases where the at least one membrane is not attached or otherwise in contact with the surface of the anode, the fuel cell of the present invention may further comprise a pressure relief device which is arranged to allow the gas to escape from a space between the anode and the at least one membrane. In one aspect, the pressure relief device may be arranged to allow the gas to escape into the fuel chamber. In another aspect, the pressure relief device may comprise a small diameter tube.

In another aspect of the fuel cell of the present invention, the at least one membrane and the spacer structure together may form an integral structure.

In yet another aspect, the fuel cell may comprise at least a first membrane adjacent to the anode and a second membrane on the side of the first membrane that faces the fuel chamber. At least the first membrane is structured and arranged to allow gas which is formed on or in the vicinity of the surface of the anode which faces the fuel chamber to accumulate adjacent to the anode at least to a point where the accumulated gas substantially prevents a direct contact between the anode and the liquid fuel.

In one aspect, the second membrane may be structured and arranged to filter solids from the liquid fuel and/or protect the first membrane. In another aspect, the first membrane and the second membrane may form an integral structure.

In yet another aspect, the second membrane may comprise a material that is different from that of the first membrane and/or may have a thickness that is different from that of the first membrane and/or may have a pore size or cell size that is different from that of the first membrane.

In a still further aspect, the second membrane may comprises a material that is substantially the same as that of the first membrane and/or may have a thickness that is substantially the same as that of the first membrane and/or may have a pore size or cell size that is substantially the same as that of the first membrane.

Except for the presence of at least two membranes, the fuel cell may be the same as the fuel cell set forth above that has (at least) one membrane. For example, at least the first membrane may comprise a polymer mesh or porous polymer layer that has a thickness of between about 0.02 mm and 2 mm and a cell size of from about 0.01 mm to about 0.1 mm or a pore size of from about 0.01 μm to about 0.1 mm, or at least the first membrane may comprise a stainless steel mesh having a thickness of from about 0.01 mm to about 5 mm. Further, the first membrane may be bonded to and/or in contact with the surface of the anode that faces the fuel chamber. Also, the fuel cell may further comprise a free space and/or a spacer structure arranged between the first membrane and the anode. The spacer structure may be the same as the spacer structure described above, including the various aspects thereof.

In another aspect of the fuel cell of the present invention, the anode may be fixed within the fuel cell (case) and/or in sealing engagement with the fuel cell (case).

In another aspect of the fuel cell of the present invention, the fuel chamber may comprise at least a first part that is adjacent to the at least one membrane and at least one second part that is connected to the first part by one or more liquid passageways. For example, the at least one second part of the fuel chamber may comprise an (optionally disposable) liquid fuel cartridge.

In a still further aspect, the fuel cell of the present invention may comprise a case which accommodates at least the anode, at least one part of the fuel chamber may be arranged outside the case, and the case may be connected to the at least one part of the fuel chamber that is arranged outside the case through one or more liquid passageways. The at least one part of the fuel chamber that is arranged outside the case may comprise an (optionally disposable) cartridge. For example, in this case the at least one membrane may be arranged in one or more of the following locations: (a) at or in a vicinity of one or more locations of the case where liquid fuel from the at least one part of the fuel chamber that is arranged outside the case can enter the case, (b) at or in a vicinity of one or more locations of the at least one part of the fuel chamber that is arranged outside the case where liquid fuel can leave the at least one part of the fuel chamber that is arranged outside the case, and (c) at one or more locations inside the one or more liquid passageways.

The present invention further provides a method for reducing or substantially preventing decomposition of a fuel in a direct liquid fuel cell at an anode of the fuel cell when the fuel cell is under substantially no load and wherein a gas is generated as a result of the fuel decomposition. The method comprises causing gas that is generated by the initial decomposition of the fuel to form a barrier that restricts or substantially prevents further contact between the fuel and the anode.

In one aspect, the barrier may comprise a substantially continuous layer of gas across substantially the entire surface of the anode that faces the fuel chamber of the fuel cell.

In another aspect, the gas may comprise hydrogen and/or the fuel may comprise at least one of a hydride compound and a borohydride compound, e.g., an alkali metal (e.g., sodium) borohydride that is dissolved and/or suspended in a liquid carrier.

In yet another aspect of the method, the fuel decomposition may be substantially stopped within not more than about 5 minutes, e.g., not more than about 3 minutes, after the fuel cell is placed under substantially no load.

In a still further aspect, the method may comprise limiting or substantially preventing the ability of the gas that is generated by the initial fuel decomposition to flow away from the anode. This may be accomplished, for example, by at least one membrane that is arranged on the side of the anode that faces the fuel chamber of the fuel cell.

The present invention further provides a method for reducing or substantially preventing fuel decomposition at an anode of a direct liquid fuel cell which uses a fuel that generates a gas when undergoing said decomposition. The method comprises arranging, between the fuel chamber of the fuel cell and the anode, one or more of at least one porous structure, at least one mesh structure, and at least one membrane, and allowing the gas to be formed during an initial decomposition of the fuel in the fuel cell, whereby the gas restricts or substantially prevents contact between the fuel and the anode.

In one aspect, the forming of gas may further comprise substantially preventing, with the gas, the fuel from contacting the anode. In another aspect, it may further comprise the formation of a substantially continuous layer of gas across substantially the entire surface of the anode that faces the fuel chamber of the fuel cell. In yet another aspect, it may further comprise a substantial confinement of the gas between the anode and the at least one porous structure, the at least one mesh structure and/or the at least one membrane.

In another aspect of the method, the gas may comprise hydrogen.

In yet another aspect, the method may further comprise placing the fuel cell under substantially no load so as to cause fuel decomposition.

In a still further aspect, the method may further comprise substantially stopping the initial fuel decomposition within not more than about 3 minutes.

In another aspect, the method may further comprise providing a space between the anode and the at least one porous structure, the at least one mesh structure and/or the at least one membrane, the space being capable of being substantially filled with the gas.

The present invention also provides a method of preventing or reducing fuel decomposition in the fuel cell set forth above, including the various aspects thereof. The method comprises generating electrical energy with the fuel cell, substantially preventing the fuel cell from further generating electrical energy, whereby fuel decomposition is caused at the anode of the fuel cell with generation of a gas; and (a) facilitating, with the at least one membrane, an accumulation adjacent to the anode of the gas generated at the anode at least to a point where the accumulated gas limits or substantially prevents contact between the anode and the liquid fuel; or (b) causing the gas generated at the anode to accumulate adjacent to the anode at least to a point where the accumulated gas substantially prevents contact between the anode and the liquid fuel; or (c) allowing the gas generated at the anode to accumulate between the at least one membrane and the anode at least to a point where the accumulated gas substantially prevents contact between the anode and the liquid fuel.

The invention also provides a fuel cell that comprises a cathode, an anode and an electrolyte chamber which is arranged between the cathode and the anode. A cartridge comprising a fuel chamber can be connected and/or removably connected to the fuel cell housing (case) having the cathode, anode and electrolyte chamber. When the cartridge is connected to the housing, the fuel chamber is arranged on that side of the anode which is opposite to the side which faces the electrolyte chamber. At least one membrane (and possibly also a spacer material) can be arranged between the gas accumulation space adjacent the anode and the fuel chamber. The at least one membrane is structured and arranged to allow gas which is formed, as a result of the fuel decomposition, on or in the vicinity of the surface of the anode that faces the fuel chamber to accumulate adjacent to the anode at least to a point where the gas substantially prevents a direct contact between the anode and the liquid fuel.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic cross section view of a prior art fuel cell;

FIG. 2 shows a cross section of a fuel cell according to one embodiment of the invention;

FIG. 3 shows an enlarged portion of FIG. 2;

FIG. 4 presents a chart illustrating hydrogen productivity in a fuel cell of the type shown in FIG. 1;

FIG. 5 presents a chart illustrating hydrogen productivity in a fuel cell of the type shown in FIG. 2;

FIG. 6 shows a partial view of one non-limiting weave pattern for the wattled spacer material;

FIG. 7 shows a partial view of another non-limiting weave pattern for the wattled spacer material;

FIG. 8 shows a cross section of a fuel cell according to another embodiment of the invention;

FIG. 9 shows a cross section of a fuel cell according to still another embodiment of the invention;

FIG. 10 shows a cross section of a fuel cell according to yet another embodiment of the invention;

FIG. 11 shows a cross section of a fuel cell according to yet another embodiment of the invention. This embodiment uses a cartridge containing the fuel chamber (or at least a part thereof) which can be connected and/or removably mounted to the housing of the fuel cell;

FIG. 12 shows an enlarged view of the embodiment shown in FIG. 11 and illustrates how the membrane and/or spacer material can have the form of small screen filter member. This figure also illustrates how the tubes of the cartridge are sealed relative to openings in the wall of the housing via o-rings; and

FIG. 13 shows a cross section of a fuel cell according to the embodiment of FIG. 11 with the cartridge separated and/or unconnected with the housing of the fuel cell.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

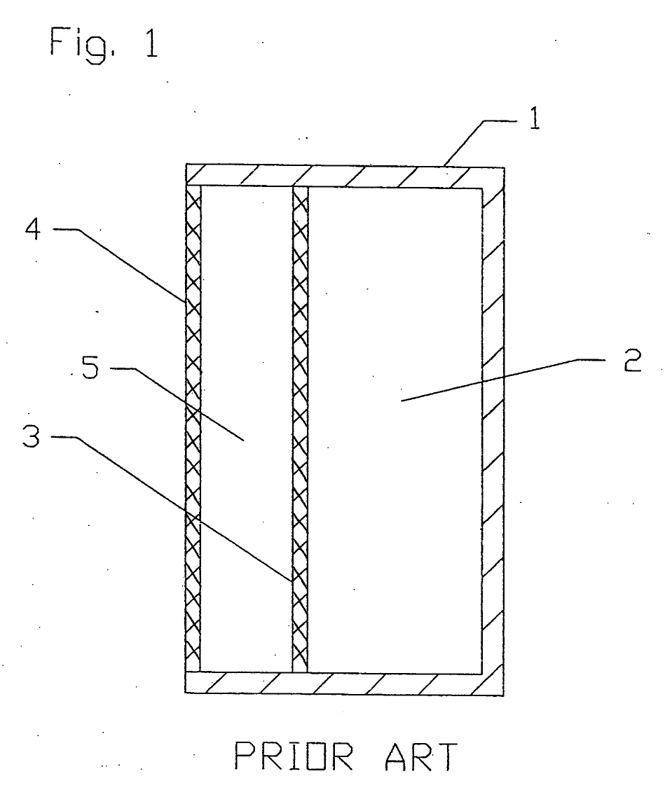

As illustrated in FIG. 1, a conventional DLFC utilizes a case or container body 1 which contains therein a fuel chamber 2 and an electrolyte chamber 5. The case 1 is typically formed of, e.g., a plastic material. The fuel chamber 2 contains liquid fuel in the form of, e.g., a hydride or borohydride fuel. The electrolyte chamber 5 contains liquid electrolyte in the form of, e.g., an aqueous alkali metal hydroxide. An anode 3 is arranged within the case 1 and separates the two chambers 2 and 5. The anode 3 will usually comprise a porous material that is pervious to gaseous and liquid substances. A cathode 4 is also arranged in the case I and, together with the anode 3, defines the electrolyte chamber 5. At the anode 3 an oxidation of the liquid fuel takes place. At the cathode 4 a substance, typically oxygen in the ambient air, is reduced.

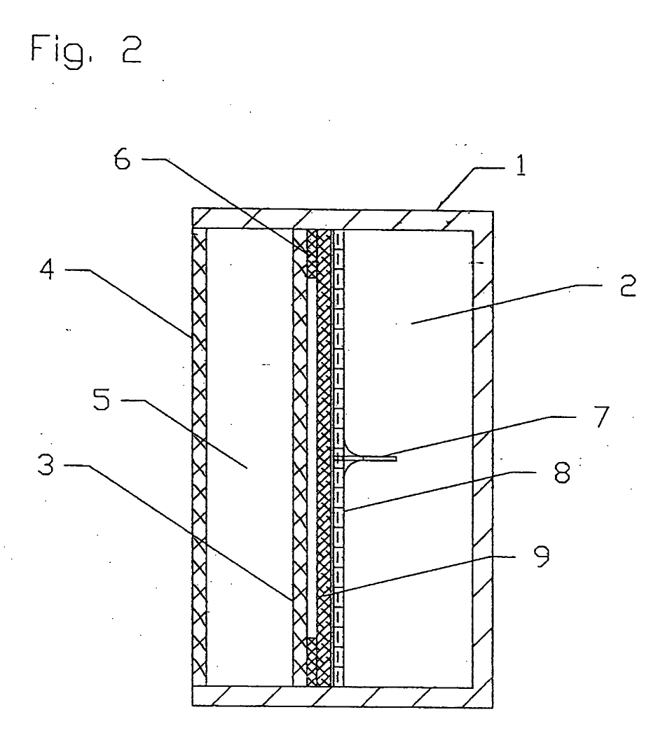

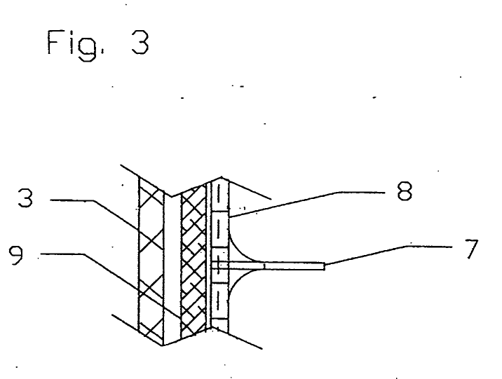

As illustrated in FIG. 2, the DLFC, according to at least one non-limiting embodiment of the invention, differs from the fuel cell illustrated in FIG. 1 at least in that it additionally comprises, arranged inside the case 1, a frame seal 6, a special membrane 8, a spacer material 9, and an optional pressure bleeding device having the form of, e.g., a capillary needle 7.

In the DLFC according to the invention, the generated gas, usually hydrogen and usually in the form of micro-bubbles of a size of from about 0.01 to about 2 mm, accumulates into a space between a surface of the anode 3 and the special membrane 8. The bubbles will usually coalesce and/or unite to form a layer of gas which fills essentially all of the volume between the anode 3 and the special membrane 8. This, in turn, causes the liquid fuel to be separated from the anode 3. The special membrane 8 substantially prevents any further contact between the liquid fuel and the anode 3. The space between the anode 3 and the membrane 8 will usually be from about 0.1 mm to about 3.0 mm thick, and preferably has a thickness of from about 0.5 mm to about 1.5 mm, and most preferably about 0.5 mm.

Any extra gas which exceeds the volume of the space between the anode 3 and the special membrane 8 vents or bleeds out and into the fuel chamber 2 through the optional capillary needle 7. This bleeding process stops essentially automatically when the pressure in the volume between the anode 3 and the special membrane 8 equals the pressure in the fuel chamber 2.

The frame seal 6 extends around the perimeter of the anode 3 and is arranged between the anode 3 and the special membrane 8. The frame seal 6 preferably has the form of a thin (non-porous) film and is utilized to prevent fuel from escaping in the area of the borders or outer edges of the anode perimeter. The material of the frame seal 6 will usually be hydrophobic (at least on the surface thereof which faces the fuel chamber) and can be formed from a material such as, e.g., polytetrafluoroethylene, although other hydrophobic materials such as, e.g., olefin polymers like polyethylene and polypropylene may also be used for this purpose. In general, the frame seal 6 will be made of or at least include a fluorinated polymer such as, e.g., a fluorinated or perfluorinated polyolefin. It is to be noted that the frame seal 6 may also be made of a material that is not hydrophobic as such but has been rendered hydrophobic on the surface thereof by way of, e.g., coating with a hydrophobic material, or any other procedure which affords hydrophobicity. Preferably, the frame seal 6 has a thickness of not more than about 0.1 mm. It will usually have a thickness of at least about 0.02 mm. A thickness of about 0.05 mm is particularly preferred for the frame seal 6 for use in the present invention. The frame seal 6 may be mounted on the anode 3 in many ways, e.g., with application of pressure and/or by using an adhesive. A preferred way of mounting the frame seal 6 comprises insert molding. The frame seal 6 can also be replaced by fixing and/or sealingly attaching a perimeter frame of the anode 3 to anode 3 by, e.g., friction welding.

The spacer material 9 is arranged between the anode 3 and the special membrane 8. The spacer material 9 also extends to the inside perimeter of the case 1 and, in the perimeter area, is also arranged between the frame seal 6 and the special membrane 8. The purpose of the spacer material 9 is to create a separation distance between the special membrane 8 and the surface of the anode 3. This separation distance forms space or volume for the gas layer. As the gas is generated, it accumulates within and fills this space. The spacer material 9 will permit the essentially free flow of gas across the surface of the anode 3, and may be in the form of a net such as, e.g., a wattled net material. The spacer material 9 must be able to withstand the chemical attack by the components of the liquid fuel and will usually be hydrophobic, at least on the outer surfaces thereof. In other words, the spacer material 9 may also be a hydrophilic material which has been made hydrophobic on the other surfaces thereof by any process suitable for this purpose such as e.g., coating with a hydrophobic material. Preferred spacer materials for use in the present invention include organic polymers such as, e.g., olefin homopolymers and olefin copolymers. Specific examples thereof include materials which may also be used for the frame seal 6 such as, e.g., homo- and copolymers of ethylene and propylene, polytetrafluoroethylene, and the like. The spacer material 9 can also be made of other materials such as, e.g., ABS, polymethylmethacrylate, polyvinyl chloride, polysulfone and similar organic polymers. The spacer material 9 will usually have a thickness of not more than about 5 mm, preferably not more than about 3 mm, more commonly a thickness of not more than about 1.5 mm. The spacer material 9 will usually have a thickness of at least about 0.1 mm, preferably at least about 0.5 mm. In a preferred embodiment of the present invention, the spacer material 9 has a thickness of about 0.5 mm. Of course, the spacer material 9 can also be dispensed with (its function being performed by another structure and/or the special membrane 8 itself as is the case with other embodiments that will be described below. As set forth above, the same applies to the frame seal 6.

As explained above, the special membrane 8 separates the gas layer which has formed at the anode surface from liquid fuel in the fuel chamber 2. The special membrane 8 is made of a material which can withstand the chemical attack by the components of the liquid fuel and will not catalyze a decomposition of the fuel or a component thereof to any appreciable extent. This material may be hydrophilic or hydrophobic. The hydrophilic material can also be a hydrophobic material which has been rendered hydrophilic on the outer surface thereof by any suitable process, such as coating, surface treatment (e.g., oxidation) and the like. Preferred non-limiting examples of suitable hydrophilic materials for the special membrane 8 include metals, as such or in the form of alloys. Particularly preferred materials include corrosion-resistant metals (e.g., nickel) and corrosion-resistant alloys such steel, in particular, stainless steel, etc.

Preferred non-limiting examples of suitable hydrophobic materials for the special membrane 8 include organic polymers such as, e.g., polyolefins (for example, homo- and copolymers of, e.g., ethylene or propylene), polyamides and polyacrylonitrile. The hydrophilic or hydrophobic material will preferably be present in the form of a foam, a mesh and the like.

By way of non-limiting example, the special membrane 8 may be or at least include a metal mesh such as, e.g., a stainless steel micromesh. The cells of the mesh may, for example, have a size of up to about 0.5 mm, e.g., up to about 0.1 mm, or up to about 0.06 mm. A preferred mesh cell size is from about 0.05 μm to about 0.06 mm, a size of about 0.05 mm being particularly preferred. The metal mesh preferably has a thickness of from about 0.01 mm to about 5 mm, e.g., from about 0.03 mm to about 3 mm.

Other non-limiting examples of the special membrane 8 include a polymer mesh or a porous polymer layer. Preferably, the polymer mesh or porous polymer layer will have a thickness of from about 0.02 mm to about 2 mm. The cell size or pore size thereof will preferably be from about 0.01 mm to about 0.1 mm and from about 0.01 μm to about 0.1 mm, respectively.

The membrane 8 may also comprise other hydrophilic and/or hydrophobic materials, e.g., composites and/or laminates of hydrophilic materials, hydrophobic materials and combinations of hydrophilic and hydrophobic materials. The membrane 8 can also comprise, e.g., a non-woven material, foam materials (polymeric or metallic) and other porous materials such as porous papers, cloths and carbon (e.g., in the form of graphite), sintered metals, and ceramic materials.

The capillary needle 7 is secured to the special membrane 8 and can be arranged at a convenient position thereon such as, e.g., centrally located (and, preferably, substantially perpendicular to the membrane 8). As explained above, the purpose of the needle 7 is to balance the pressure between gas layer and liquid fuel in the fuel chamber 2. The balance pressure range will usually be from about 1 atm to about 1.5 atm (absolute). The needle 7 is made of a material which can withstand the chemical attack by the components of the liquid fuel and does not catalyze a decomposition thereof to any appreciable extent. This material will usually be selected from the materials which are suitable for making the special membrane 8, but may also be made of other materials, e.g., polymeric materials. Non-limiting examples of polymeric materials include polyolefins such as polytetrafluoroethylene and polypropylene. Preferably, the needle 7 is a stainless steel needle. While a suitable length of the needle 7 may vary over a wide range (depending, in part on the dimensions of the spacer 9, the membrane 8, etc.) the needle 7 will often have a length of up to about 2 cm, or even longer. The inner diameter of the needle 7 will usually not exceed about 2 mm, preferably not exceed about 1 mm, or not exceed about 0.5 mm. The needle 7 may be attached to the membrane 8 by any suitable method, e.g., by using a thermoadhesive, welding and mechanical attachment (the latter being a preferred method). Of course, the needle 7 is not essential for the operation of the fuel cell of the present invention and can also be dispensed with, as in the case of the other embodiments that will be described below.

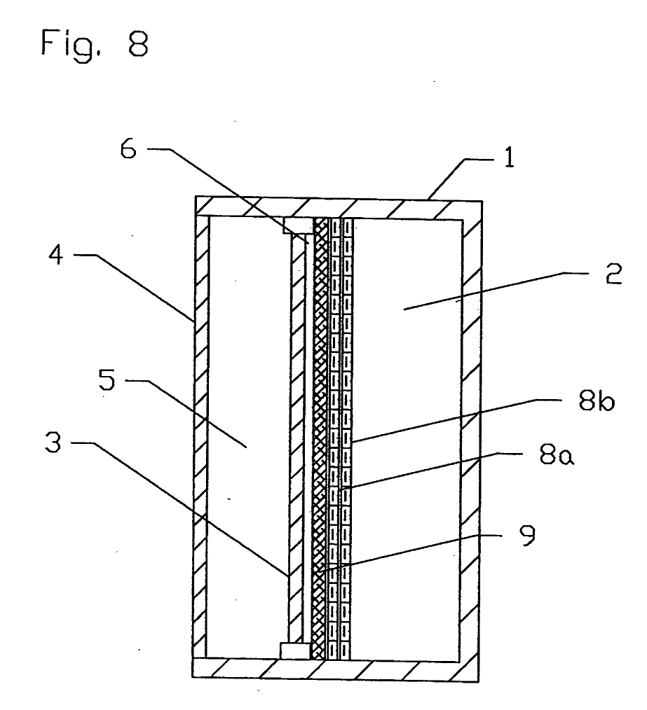

FIG. 8 shows another non-limiting embodiment of the fuel cell of the present invention that differs from the fuel cell illustrated in FIG. 1 at least in that it additionally comprises, arranged inside the case 1, an anode 3 having a frame, a special membrane 8a, an optional second membrane 8b, and an optional spacer material 9. This embodiment eliminates the need for the frame seal 6 and also does not comprise the capillary needle 7. The perimeter frame of the anode 3 can be fixed to the anode 3 by, e.g., friction welding. The materials and thicknesses of the devices 3, 4, 9, 8a and 8b can be the same as the corresponding devices described above with regard to the embodiment shown in FIG. 2. The membranes 8a and 8b may be of the same material, types and/or thicknesses as described above or may be different in anyone or more of these respects.

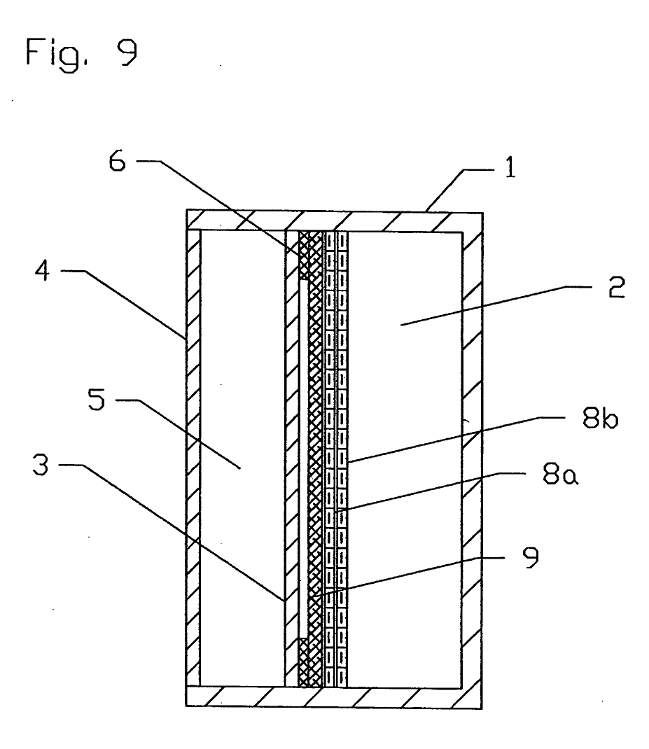

FIG. 9 shows another non-limiting embodiment of the fuel cell of the present invention that differs from the fuel cell illustrated in FIG. 1 at least in that it additionally comprises, arranged inside the case 1, an anode 3, a special membrane 8a, an optional second membrane 8b, an optional spacer material 9, and an optional frame seal 6. This embodiment also does not comprise the capillary needle 7. The materials and thicknesses of the devices 3, 4, 6, 9, 8a and 8b can be the same as the corresponding devices described above with regard to the embodiment shown in FIG. 2. The membranes 8a and 8b may be of the same material, types and/or thicknesses as described above or may be different in anyone or more of these respects.

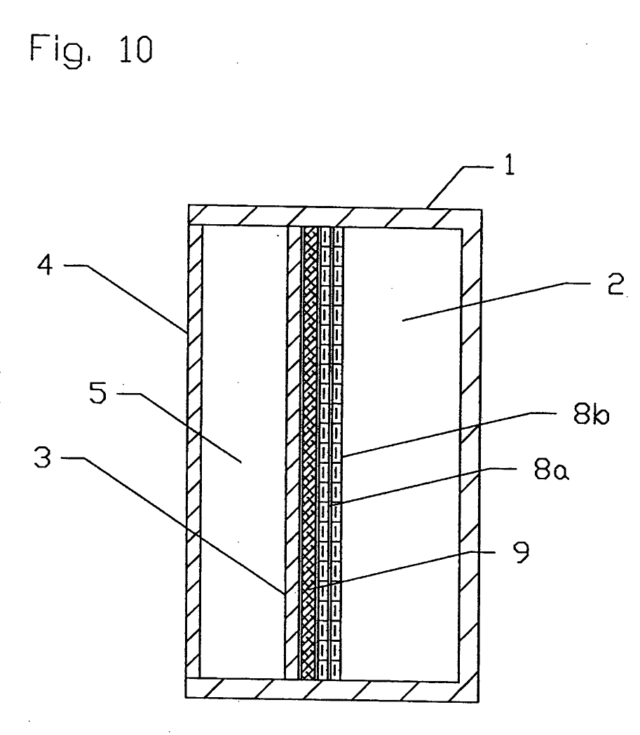

FIG. 10 shows another non-limiting embodiment of the fuel cell of the present invention that differs from the fuel cell illustrated in FIG. 1 at least in that it additionally comprises, arranged inside the case 1, an anode 3, and a special membrane 8a, and an optional second membrane 8b. This embodiment eliminates the need for the spacer material 9 and the frame seal 6, and also does not comprise the capillary needle 7. The materials and thicknesses of the devices 3, 4, 8a and 8b can be the same as the corresponding devices described above with regard to the embodiment shown in FIG. 2. The membranes 8a and 8b may be of the same material, types and/or thicknesses as described above or may be different in anyone or more of these respects. In this embodiment, the membrane 8a is preferably in contact with the anode 3. By way of non-limiting example, the membrane 8a can be rolled or otherwise attached or bound to the surface of the anode 3. In this case, the voids and/or free space in the membrane 8a provide the empty space that can be occupied by the generated gas to thereby form a barrier that substantially prevents the fuel from contacting the anode.

Particularly in embodiments which utilize more than one special membrane 8a, e.g., two membranes 8a and 8b, the first membrane 8a can function in the manner described above with regard to the space and/or spacer material whereas the second membrane 8b can serve a different function such as, e.g., filter solids and the like from the fuel in the fuel chamber 2 in order to protect the first membrane 8a and/or substantially prevent a clogging thereof.

Those of skill in the art will appreciate that not each of the various components of the fuel cell of the present invention has to be present as a single component and also does not have to be arranged completely inside a single case. By way of non-limiting example, the fuel chamber 2 may comprise one part that is adjacent to the at least one membrane 8 (e.g., adjacent to membrane 8b) and one or more other parts (e.g., one or more cartridges) that are arranged outside the housing or case of the fuel cell and are connected to the case through one or more liquid passageways. The volume of the part of the fuel chamber that is arranged within the case, if any, may be small compared to the volume of the one or more parts that are arranged outside the case (e.g., not more than about 20%, e.g., not more than about 10%, not more than about 5%, or not more than about 2% of the latter volume). Further, the fuel chamber 2 may be arranged substantially completely outside the case, and may be connected to the case by one or more liquid passageways (e.g., in the form of small diameter tubes and the like). By way of non-limiting example, the fuel chamber may be in the form of an (optionally disposable) cartridge that is connected to the case. Exemplary ways of connecting a cartridge to a case are disclosed, e.g., in co-pending U.S. application Ser. Nos. 10/824,443 and 10/849,503, the entire disclosures whereof are expressly incorporated by reference herein.

In this case, the at least one membrane 8 may be comprised by the case (e.g., at or in the vicinity of one or more points where liquid fuel can enter the case) and/or may be comprised by the fuel chamber 2 (e.g., the cartridge). (e.g., at or in the vicinity of one or more points where liquid fuel can leave the fuel chamber 2) and/or may be arranged somewhere in between the case and the fuel chamber 2 (e.g., within the one or more liquid passageways that connect the fuel chamber 2 and the case). Of course, in this case the details regarding the various components of the fuel chamber may be the same as those set forth above. For example, the at least one membrane 8 may comprise at least a first membrane 8a and a second membrane 8b.

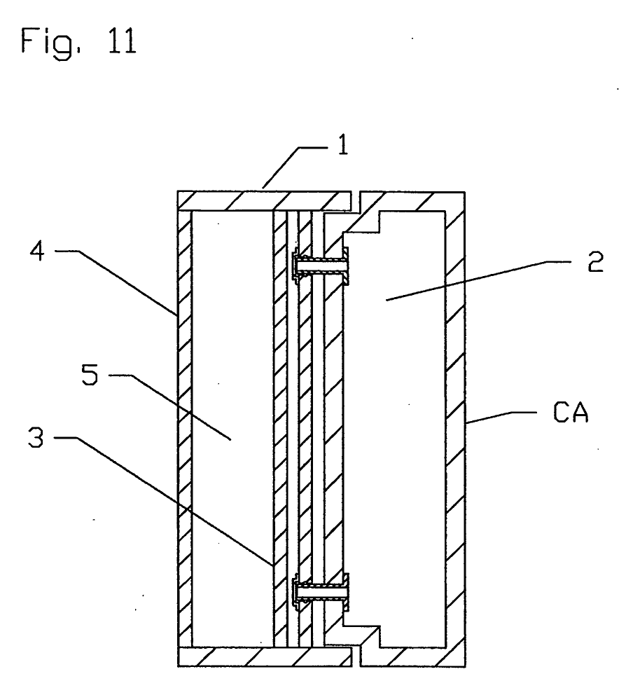

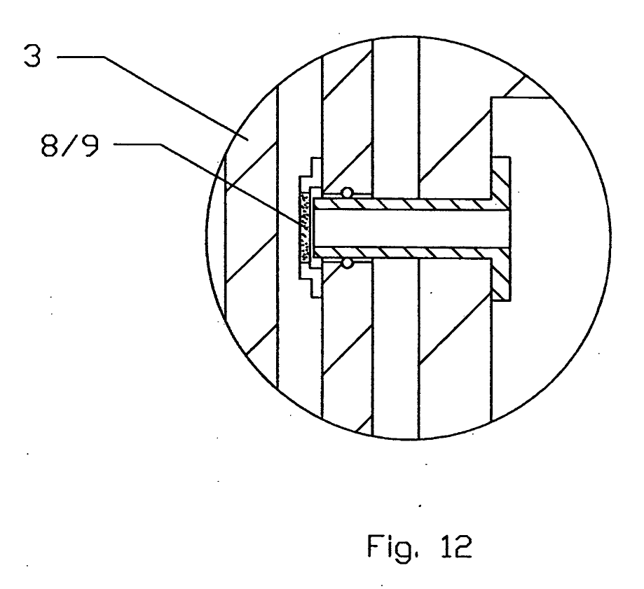

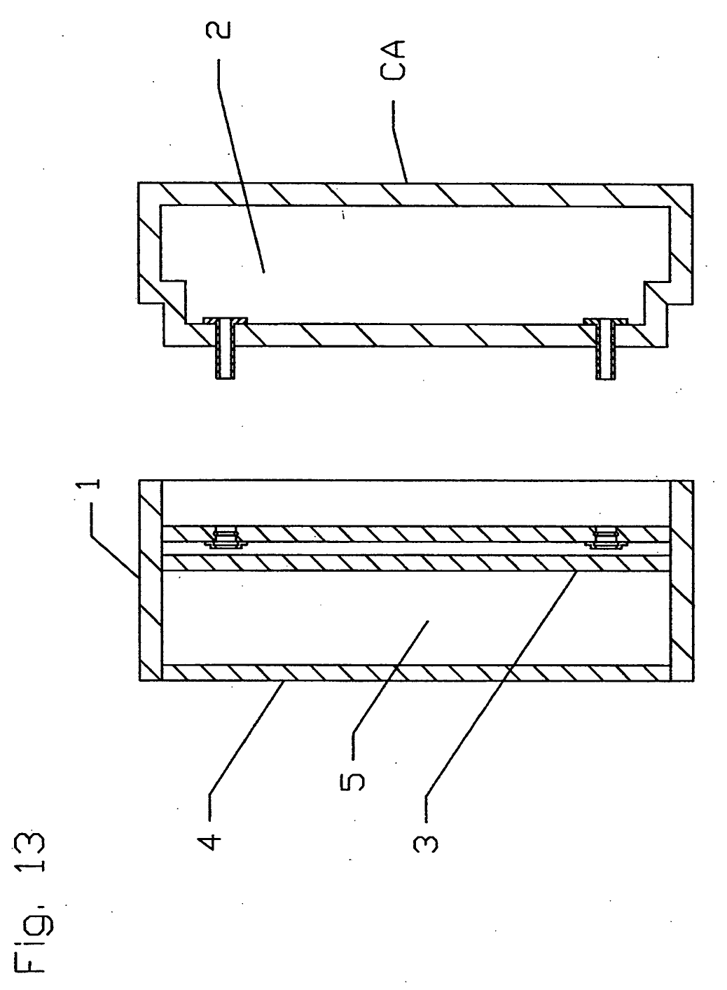

FIGS. 11-13 show one non-limiting embodiment of a fuel cell 1 having a cathode 4, an anode 3, an electrolyte chamber 5 which is arranged between the cathode 4 and the anode 3. A cartridge CA having a fuel chamber 2 is connected and/or removably connected to the fuel cell housing having the cathode 4, anode 3 and electrolyte chamber 5. When the cartridge CA is connected to the housing (FIG. 11), the fuel chamber 2 is arranged on that side of the anode 3 which is opposite to the side which faces the electrolyte chamber 5. At least one membrane 8 is arranged between the gas accumulation space adjacent the anode 3 and the fuel chamber 2. By way of non-limiting example, the width of this space can be approximately 1 mm, but may be considerably larger or smaller. The at least one membrane 8 is structured and arranged to allow gas which is formed, as a result of the fuel decomposition, on or in the vicinity of the surface of the anode 3 that faces the fuel chamber 2 to accumulate adjacent to the anode 3 at least to a point where the gas substantially prevents a direct contact between the anode 3 and the liquid fuel in the fuel chamber 2. As can be seen in FIG. 12, the membrane 8 (which can also include an additional layer of spacer material 9) can have the form of small screen filter member that is fixed to the inner surface of a wall of the housing. Of course, the filter element can also be arranged on the opposite end of the tubes so as to be arranged in the cartridge CA without leaving the scope of the invention. Further, a filter element can be arranged on both sides of the tubes. Still further, the inside of the tubes can include the membrane/spacer material, which can have the form of a cigarette filter of sufficient length. As can be seen in FIG. 13, the tubes (the numbers and sizes of which can vary as desired and can be similar to that described with regard to tube 7) of the cartridge CA are sealed relative to openings in the wall of the housing via one or more o-rings. Of course, any number of sealing techniques or methods may also be employed in providing sealing between the tubes and the openings on the wall of the housing. Still further, it is contemplated that the tubes can instead be coupled to the fuel cell housing while openings are arranged in the wall of cartridge CA. FIG. 13 shows the cartridge CA being separated and/or unconnected from the housing of the fuel cell 1. Although not shown, valves can be utilized to stop and/or regulate flow from and to the cartridge CA and the housing of the fuel cell 1.

By way of non-limiting explanation, when the fuel cell is or is placed under no or substantially no load, liquid fuel will initially decompose and generate gas (e.g., hydrogen) in the vicinity of the anode 3, thereby pushing the liquid fuel away from the anode 3 and preventing further fuel from contacting the anode 3, which in turn terminates the generation of gas. When the fuel cell is thereafter placed under load (closed electrical circuit), the gas will be consumed by oxidation on the surface of the anode, thereby creating a vacuum which sucks liquid fuel back and into direct contact with the surface of the anode 3, where it will be oxidized to generate electrical energy. When the circuit is opened again (no load), gas will initially be generated through decomposition of the liquid fuel, and the above-described process will start from the beginning.

### EXAMPLE 1

A conventional DLFC of the type shown in FIG. 1 with the following parameters was employed for testing:
Area of anode and cathode=each 45 cm² (62 mm×73 mm);
Thickness or width of electrolyte chamber=4 mm;
Volume of electrolyte in the electrolyte chamber=18 cm³;
Thickness or width of fuel chamber=20 mm; and
Volume of fuel in the fuel chamber=90 cm³.

The DLFC was filled with a borohydride fuel and tested under the following conditions:
Full time of test=20 hours;
Unloading regime=open circuit.

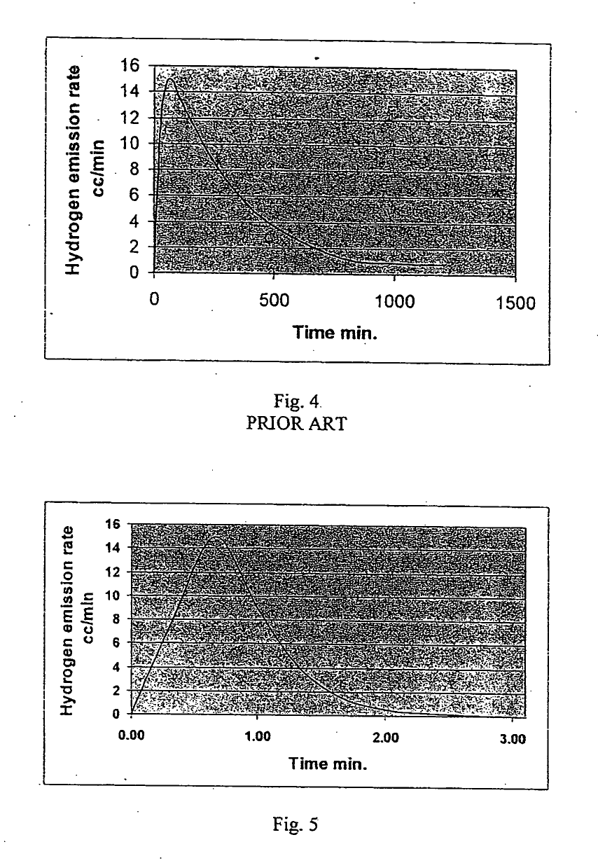

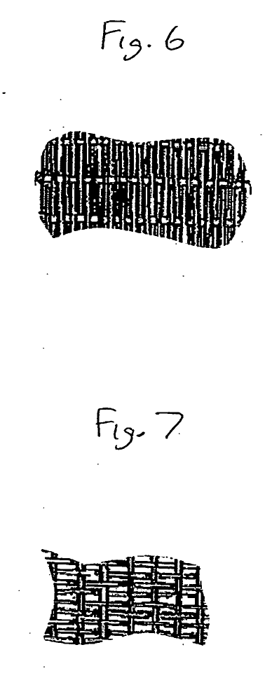

In this test, the maximum gas productivity was 15 cm³/min. As can be seen from FIG. 4, the generation of hydrogen begins to decrease after about 60 minutes, but continues over the full 20 hours of the test.

### EXAMPLE 2

A DLFC according to the present invention of the type shown in FIG. 2 with the following parameters was employed for testing:
Area of anode and cathode=each 45 cm² (62 mm'73 mm);
Thickness or width of electrolyte chamber=4 mm;
Volume of electrolyte in the electrolyte chamber=18 cm³;
Thickness or width of fuel chamber=20 mm;
Volume of fuel in the fuel chamber=90 cm³;
Thin film Teflon frame-seal thickness=50 μm;
Stainless steel capillary needle length=7 mm, Inside Diameter=320 μm;
Stainless steel micromesh special membrane with cells=53 μm; and
Polypropylene wattled net spacer material with cells of 2 mm×3 mm and with a thickness=1 mm.

The DLFC was filled with a borohydride fuel and tested under the following conditions:
Full time of test=20 hours;
Unloading regime=open circuit.

In this test, the time until the space between the anode 3 and the special membrane 8 was filled was 45 seconds. As can be seen from FIG. 5, the generation of hydrogen began to decrease after about 45 seconds, and stopped after about 3 minutes, i.e., the fuel decomposition stopped after about 3 minutes.

It is to be noted that the exemplary and preferred dimensions of the various elements of the DLFC described above apply particularly to fuel cells for portable devices, e.g., for fuel cells which have dimensions of an order of magnitude which is suitable for portable devices (e.g., laptops, cell phones etc.). Examples of corresponding dimensions are given in the Examples herein. For fuel cells which are considerably smaller or larger than those which are suitable for portable devices, the preferred dimensions given herein may not always afford the desired result to the fullest possible extent. One of ordinary skill in the art will, however, be able to readily ascertain the most suitable dimensions for any given size of fuel cell.

As used herein, a “hydrophilic” material is a material that has an affinity for water. The term includes materials which can be wetted, have a high surface tension value and have a tendency to form hydrogen-bonds with water. It also includes materials which have high water vapor permeability.

As used herein, a “hydrophobic” material is a material which repels water. The term includes materials which allow for the passage of gas therethrough but which substantially prevent the flow therethrough of water and similar protic and/or polar liquids.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A direct liquid fuel cell for use with a liquid fuel that is prone to undergo decomposition with generation of a gas, the fuel cell comprising:
a cathode;
an anode;
an electrolyte chamber arranged between the cathode and the anode;
a fuel chamber arranged on a side of the anode which is opposite to a side which faces the electrolyte chamber; and
at least one membrane arranged on a side of the anode which faces the fuel chamber,
wherein the at least one membrane is structured and arranged to allow gas which is formed on or in the vicinity of a surface of the anode which faces the fuel chamber to accumulate adjacent to the anode at least to a point where the accumulated gas substantially prevents a direct contact between the anode and liquid fuel from the fuel chamber.

2. The fuel cell of claim 1, wherein the gas comprises hydrogen.

3. The fuel cell of claim 1, wherein the fuel comprises at least one of a metal hydride compound and a metal borohydride compound.

4. The fuel cell of claim 1, wherein the at least one membrane comprises a single layer of material.

5. The fuel cell of claim 1, wherein the at least one membrane comprises a hydrophilic material.

6. The fuel cell of claim 5, wherein the hydrophilic material comprises at least one of a metal and a metal alloy.

7. The fuel cell of claim 6, wherein the hydrophilic material comprises stainless steel.

8. The fuel cell of claim 1, wherein the at least one membrane comprises a hydrophobic material.

9. The fuel cell of claim 8, wherein the hydrophobic material comprises an organic polymer.

10. The fuel cell of claim 8, wherein the hydrophobic material comprises at least one of a polyolefin, a polyamide and polyacrylonitrile.

11. The fuel cell of claim 1, wherein the at least one membrane comprises at least one of a non-woven material, a composite material, a laminate material, a composite/laminate material, a foam material, a porous paper material, a cloth material, a carbon/graphite material, a sintered metal material, a ceramic material, and a polymer material.

12. The fuel cell of claim 1, wherein the at least one membrane comprises at least one of a mesh and a foam.

13. The fuel cell of claim 12, wherein the at least one membrane comprises a stainless steel micromesh.

14. The fuel cell of claim 13, wherein the micromesh comprises cells having a size of up to about 0.5 mm.

15. The fuel cell of claim 14, wherein the cells have a size of from about 0.06 μm to about 0.05 mm

16. The fuel cell of claim 13, wherein the mesh has a thickness of from about 0.01 mm to about 5 mm.

17. The fuel cell of claim 1, wherein the at least one membrane comprises at least one of a polymer mesh and a porous polymer layer.

18. The fuel cell of claim 17, wherein the polymer mesh or porous polymer layer has a thickness of from about 0.02 mm to about 2 mm.

19. The fuel cell of claim 17, wherein the polymer mesh has a cell size of from about 0.01 mm to about 0.1 mm and the porous polymer layer has a pore size of from about 0.01 μm to about 0.1 mm.

20. The fuel cell of claim 1, wherein the at least one membrane is in contact with the surface of the anode which faces the fuel chamber.

21. The fuel cell of claim 20, wherein the at least one membrane is at least one of attached and bonded to the surface of the anode.

22. The fuel cell of claim 1, wherein the fuel cell further comprises at least one of a free space and a spacer structure arranged between the at least one membrane and the anode.

23. The fuel cell of claim 22, wherein the fuel cell comprises a spacer structure comprised of a spacer material having free space therein.

24. The fuel cell of claim 23, wherein the spacer structure comprises a layer of spacer material having a thickness of up to about 3 mm.

25. The fuel cell of claim 24, wherein the layer of spacer material has a thickness of at least about 0.1 mm.

26. The fuel cell of claim 25, wherein the layer of spacer material has a thickness of from about 0.5 mm to about 1.5 mm.

27. The fuel cell of claim 23, wherein the spacer material comprises a hydrophobic material.

28. The fuel cell of claim 27, wherein the hydrophobic material comprises a polymeric material.

29. The fuel cell of claim 27, wherein the hydrophobic material comprises at least one of an olefin homopolymer, an olefin copolymer, ABS, polymethylmethacrylate, polyvinyl chloride, and polysulfone.

30. The fuel cell of claim 29, wherein the hydrophobic material comprises at least one of polyethylene, polypropylene, polytetrafluoroethylene, and ABS.

31. The fuel cell of claim 27, wherein the at least one membrane comprises a hydrophilic material.

32. The fuel cell of claim 23, wherein the spacer structure comprises a net.

33. The fuel cell of claim 32, wherein the net comprises a wattled net.

34. The fuel cell of claim 32, wherein the net comprises openings of from about 1 mm to about 50 mm.

35. The fuel cell of claim 21, wherein the fuel cell comprises a spacer structure comprised of a frame seal which is arranged on the surface of the anode which faces the fuel chamber.

36. The fuel cell of claim 35, wherein the frame seal comprises a hydrophobic material.

37. The fuel cell of claim 36, wherein the hydrophobic material comprises a polymer.

38. The fuel cell of claim 37, wherein the polymer comprises a fluorinated polymer.

39. The fuel cell of claim 35, wherein the frame seal has a thickness of up to about 0.1 mm.

40. The fuel cell of claim 39, wherein the frame seal has a thickness of from about 0.02 mm to about 0.05 mm.

41. The fuel cell of claim 23, wherein the spacer structure further comprises a frame seal which is arranged on the surface of the anode which faces the fuel chamber.

42. The fuel cell of claim 22, wherein the fuel cell further comprises a pressure relief device which is arranged to allow the gas to escape from a space between the anode and the at least one membrane.

43. The fuel cell of claim 42, wherein the pressure relief device is arranged to allow the gas to escape into the fuel chamber.

44. The fuel cell of claim 42, wherein the pressure relief device comprises a tube.

45. The fuel cell of claim 23, wherein the at least one membrane and the spacer structure form an integral structure.

46. The fuel cell of claim 1, wherein the fuel cell comprises at least a first membrane adjacent to the anode and a second membrane on a side of the first membrane which faces the fuel chamber, at least the first membrane being structured and arranged to allow gas which is formed on or in the vicinity of a surface of the anode which faces the fuel chamber to accumulate adjacent to the anode at least to a point where the accumulated gas substantially prevents a direct contact between the anode and the liquid fuel.

47. The fuel cell of claim 46, wherein the second membrane is structured and arranged to at least one of filter solids from the liquid fuel and protect the first membrane.

48. The fuel cell of claim 46, wherein the first membrane and the second membrane form an integral structure.

49. The fuel cell of claim 46, wherein the second membrane comprises at least one of a material that is different from that of the first membrane, a thickness that is different from that of the first membrane, and a pore size or cell size that is different from that of the first membrane.

50. The fuel cell of claim 46, wherein the second membrane comprises at least one of a material that is substantially the same as that of the first membrane, a thickness that is substantially the same as that of the first membrane, and a pore size or cell size that is substantially the same as that of the first membrane.

51. The fuel cell of claim 46, wherein at least the first membrane comprises a polymer mesh or porous polymer layer having a thickness of between about 0.02 mm and 2 mm and a cell size of from about 0.01 mm to about 0.1 mm or a pore size of from about 0.01 μm to about 0.1 mm.

52. The fuel cell of claim 46, wherein at least the first membrane comprises a stainless steel mesh having a thickness of from about 0.01 mm to about 5 mm.

53. The fuel cell of claim 46, wherein the first membrane is at least one of bonded to and in contact with the surface of the anode that faces the fuel chamber.

54. The fuel cell of claim 46, wherein the fuel cell further comprises at least one of a free space and a spacer structure arranged between the first membrane and the anode.

55. The fuel cell of claim 54, wherein the fuel cell comprises a spacer structure comprised of a spacer material having free space therein.

56. The fuel cell of claim 55, wherein the spacer material comprises a hydrophobic material.

57. The fuel cell of claim 55, wherein the spacer structure comprises a wattled net.

58. The fuel cell of claim 55, wherein the spacer structure comprises a frame seal which is arranged on the surface of the anode which faces the fuel chamber.

59. The fuel cell of claim 58, wherein the frame seal has a thickness of from about 0.02 mm to about 0.05 mm.

60. The fuel cell of claim 1, wherein the anode is at least one of fixed within a fuel cell case and in sealing engagement with a fuel cell case.

61. A method of reducing or substantially preventing decomposition of a fuel in a direct liquid fuel cell at an anode of the fuel cell when the fuel cell is under substantially no load, wherein the fuel decomposition generates a gas, the method comprising causing gas that is generated by an initial fuel decomposition to form a barrier that restricts or substantially prevents further contact between the fuel and the anode.

62. The method of claim 61, wherein the barrier comprises a substantially continuous layer of gas across substantially an entire surface of the anode that faces a fuel chamber of the fuel cell.

63. The method of claim 61, wherein the gas comprises hydrogen.

64. The method of claim 61, wherein the fuel comprises at least one of a hydride compound and a borohydride compound.

65. The method of claim 64, wherein the fuel comprises an alkali metal borohydride that is at least one of dissolved and suspended in a liquid carrier.

66. The method of claim 61, wherein the fuel decomposition is substantially stopped within not more than about 5 minutes after the fuel cell is placed under substantially no load.

67. The method of claim 66, wherein the fuel decomposition is substantially stopped within not more than about 3 minutes.

68. The method of claim 61, wherein the method comprises limiting or substantially preventing an ability of the gas that is generated by the initial fuel decomposition to flow away from the anode.

69. The method of claim 68, wherein the ability of the gas to flow away from the anode is limited or substantially prevented by at least one membrane that is arranged on a side of the anode that faces a fuel chamber of the fuel cell.

70. A method of reducing or substantially preventing fuel decomposition at an anode of a direct liquid fuel cell which uses a fuel that generates a gas when undergoing said decomposition, wherein the method comprises:
arranging, between a fuel chamber of the fuel cell and the anode, at least one of:
at least one porous structure;
at least one mesh structure; and
at least one membrane; and
forming a gas during an initial decomposition of the fuel in the fuel cell,
whereby the gas restricts or substantially prevents contact between the fuel and the anode.

71. The method of claim 70, wherein the forming comprises substantially preventing, with the gas, the fuel from contacting the anode.

72. The method of claim 70, wherein the forming comprises forming a substantially continuous layer of gas across substantially an entire surface of the anode that faces a fuel chamber of the fuel cell.

73. The method of claim 70, wherein the forming comprises substantially confining the gas between the anode and the at least one porous structure, the at least one mesh structure, or the at least one membrane.

74. The method of claim 70, wherein the gas comprises hydrogen.

75. The method of claim 70, further comprising placing the fuel cell under substantially no load so as to cause fuel decomposition.

76. The method of claim 75, further comprising substantially stopping initial fuel decomposition within not more than about 3 minutes.

77. The method of claim 70, further comprising providing a space between the anode and the at least one porous structure, the at least one mesh structure, or the at least one membrane, wherein the space is capable of being substantially filled with the gas.

78. A method of preventing or reducing fuel decomposition in the fuel cell of claim 1, wherein the method comprises:
generating electrical energy with the fuel cell;
substantially preventing the fuel cell from further generating electrical energy, whereby fuel decomposition is caused at the anode of the fuel cell with generation of a gas; and
facilitating, with the at least one membrane, an accumulation adjacent to the anode of the gas generated at the anode at least to a point where the accumulated gas limits or substantially prevents contact between the anode and the liquid fuel.

79. A method of preventing or reducing fuel decomposition in the fuel cell of claim 1, wherein the method comprises:
generating electrical energy with the fuel cell;
substantially preventing the fuel cell from further generating electrical energy, whereby fuel decomposition is caused at the anode of the fuel cell with generation of a gas; and
causing the gas generated at the anode to accumulate adjacent to the anode at least to a point where the accumulated gas substantially prevents contact between the anode and the liquid fuel.

80. A method of preventing or reducing fuel decomposition in the fuel cell of claim 1, wherein the method comprises:
generating electrical energy with the fuel cell;
substantially preventing the fuel cell from further generating electrical energy, whereby fuel decomposition is caused at the anode of the fuel cell with generation of a gas; and
allowing the gas generated at the anode to accumulate between the at least one membrane and the anode at least to a point where the accumulated gas substantially prevents contact between the anode and the liquid fuel.

81. The fuel cell of claim 1, wherein the fuel chamber is arranged in a cartridge that is at least one of connected to a housing of the fuel cell and removably mounted to a housing of the fuel cell.

82. The fuel cell of claim 81, wherein the fuel cell further comprises at least one member that allows liquid fuel to pass from the fuel chamber of the cartridge to an area adjacent the anode.

83. The fuel cell of claim 1, wherein the fuel cell comprises a case which accommodates at least the anode, wherein at least one part of the fuel chamber is arranged outside the case, and wherein the case is connected to the at least one part of the fuel chamber that is arranged outside the case through one or more liquid passageways.

84. The fuel cell of claim 83, wherein the at least one part of the fuel chamber that is arranged outside the case comprises a cartridge.

85. The fuel cell of claim 83, wherein the at least one membrane is arranged at least one of (a) at or in a vicinity of one or more locations of the case where liquid fuel from the at least one part of the fuel chamber that is arranged outside the case can enter the case, (b) at or in a vicinity of one or more locations of the at least one part of the fuel chamber that is arranged outside the case where liquid fuel can leave the at least one part of the fuel chamber that is arranged outside the case, and (c) at one or more locations inside the one or more liquid passageways.
